(19) United States
(12) Patent Application Publication
(10) Pub. No.: US 2023/0111577 A1
(43) Pub. Date: Apr. 13, 2023

(54) OPTICAL UNIT, VIRTUAL IMAGE DISPLAY DEVICE, AND MEASUREMENT METHOD FOR OPTICAL UNIT

(71) Applicant: SEIKO EPSON CORPORATION, Tokyo (JP)

(72) Inventors: Toshiyuki NOGUCHI, SHIOJIRI-SHI (JP); Toshiaki MIYAO, CHINO-SHI (JP); Mitsutaka IDE, SHIOJIRI-SHI (JP)

(73) Assignee: SEIKO EPSON CORPORATION, Tokyo (JP)

(21) Appl. No.: 17/960,825

(22) Filed: Oct. 6, 2022

(30) Foreign Application Priority Data
Oct. 7, 2021 (JP) 2021-165345

(51) Int. Cl. G02B 27/01

(52) U.S. Cl. CPC G02B 27/0172; G02B 2027/0178; G02B 2027/0198

(57) ABSTRACT

An optical unit and a virtual image display device, that is, an HMD include a plurality of optical members, and the plurality of optical members have, at non-coupling portion, measurement reference members that serve as references for arrangement, respectively, and the plurality of measurement reference members of the plurality of optical members are arranged in a unified direction.

The present application is based on, and claims priority from JP Application Serial Number 2021-165345, filed Oct. 7, 2021, the disclosure of which is hereby incorporated by reference herein in its entirety.

### BACKGROUND

### 1. Technical Field

The present disclosure relates to an optical unit included in a head-mounted display device or the like, a virtual image display device with the optical unit, and a measurement method for the optical unit.

### 2. Related Art

A technique for an imaging optical system incorporated into a display device in which an optical member constituting the imaging optical system, specifically a lens having a free-form surface, is provided with an edge having a cylindrical piece shape and a horizontal reference plane, the edge and the horizontal reference plane being brought in contact with a target to attach them to a measuring instrument and a lens barrel of the lens has been disclosed (JP-A-2007-127865). In this case, it is conceivable that each of optical members such as a lens and a mirror constituting the imaging optical system includes a positioning unit, each of the optical elements being held in a lens barrel, and the lens barrels being directly or indirectly coupled, and thus image quality of virtual images is ensured.

Although the above-described technique has the effect of reducing a relative positional misalignment of the optical members constituting the imaging optical system, it is difficult to exactly ascertain to what extent the optical members are misaligned in the positional relationship when they are actually assembled. As a result, the optical unit obtained by combining the plurality of optical members is difficult to modify, and the image quality of virtual images is not easily ensured and improved.

### SUMMARY

An optical unit according to an aspect of the present disclosure is an optical unit for imaging including a plurality of optical members, and the plurality of optical members are fixedly placed at coupling portions, and have, at non-coupling portions, measurement reference members that function as references for arrangement.

### BRIEF DESCRIPTION OF THE DRAWINGS

FIG. 1 is an external perspective view illustrating a state in which an HMD is worn according to a first embodiment.

FIG. 2 includes perspective views of the external appearance of the HMD and the inside thereof with the exterior member removed.

FIG. 3 illustrates a plan view and a side view of an optical unit.

FIG. 4 illustrates a front view and a side view of the optical unit.

FIG. 5 is a conceptual side cross-sectional view for describing an optical system inside the HMD.

FIG. 6 is a diagram for describing a method of fixing a prism mirror and a wedge-shaped optical element.

FIG. 7 is a diagram for describing fixing of a projection lens to an optical block main body.

FIG. 8 is a diagram for describing fixing of a combiner to an optical block.

FIG. 9 is a conceptual side view for describing a measurement reference member provided in a plurality of optical members.

FIG. 10 is a partially enlarged perspective view for describing a shape of the measurement reference member.

FIG. 11 is a conceptual diagram for describing a measurement system of an optical unit.

FIG. 12 is a side view of an optical member.

FIG. 13 is a perspective view for describing a modified example of the measurement reference member.

FIG. 14 illustrates a plan view and a side view of an optical unit according to a second embodiment.

FIG. 15 is a conceptual side view for describing an arrangement or the like of a measurement reference member.

FIG. 16 is a conceptual side view for describing a modified example of the optical unit of FIG. 15.

### DESCRIPTION OF EXEMPLARY EMBODIMENTS

### First Embodiment

A first embodiment of an optical unit and a virtual image display device according to the present disclosure will be described below with reference to the accompanying drawings.

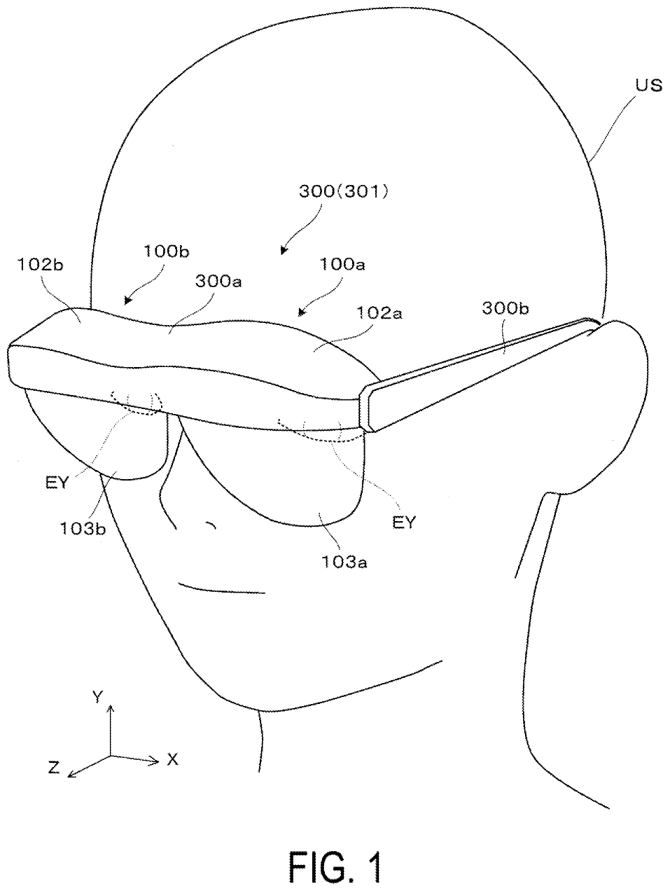

FIG. 1 is a diagram for describing a state in which an image display device 300 is worn. The image display device 300 is a head-mounted virtual image display device, in other words, a head-mounted display (hereinafter, also referred to as an “HMD”) 301, and enables an observer or a wearer US who is wearing this device to be able to recognize an image that is a virtual image. In FIG. 1 and the like, X, Y, and Z constitute an orthogonal coordinate system, a +X direction corresponds to a lateral direction in which the two eyes EY of an observer or a wearer US who is wearing the HMD 301 are lined up, a +Y direction corresponds to an upward direction orthogonal to the lateral direction in which the two eyes EY of the wearer US are lined up, and a +Z direction corresponds to the forward direction or a front direction for the wearer US. A ±Y direction is parallel to a vertical axis or a vertical direction.

The image display device 300 includes a main body device 300a placed to cover the front of the wearer US, and a pair of temple-shape support devices 300b that support the main body device 300a. The main body device 300a includes a first display device 100a for the left eye and a second display device 100b for the right eye from the perspective of function. The first display device 100a includes a first display drive part 102a placed at the upper portion thereof, and a first combiner 103a in an eyeglass lens shape covering the front of the eye. Similarly, the second display device 100b includes a second display drive part 102b placed at the upper portion thereof, and a second combiner 103b in an eyeglass lens shape covering the front of the eye.

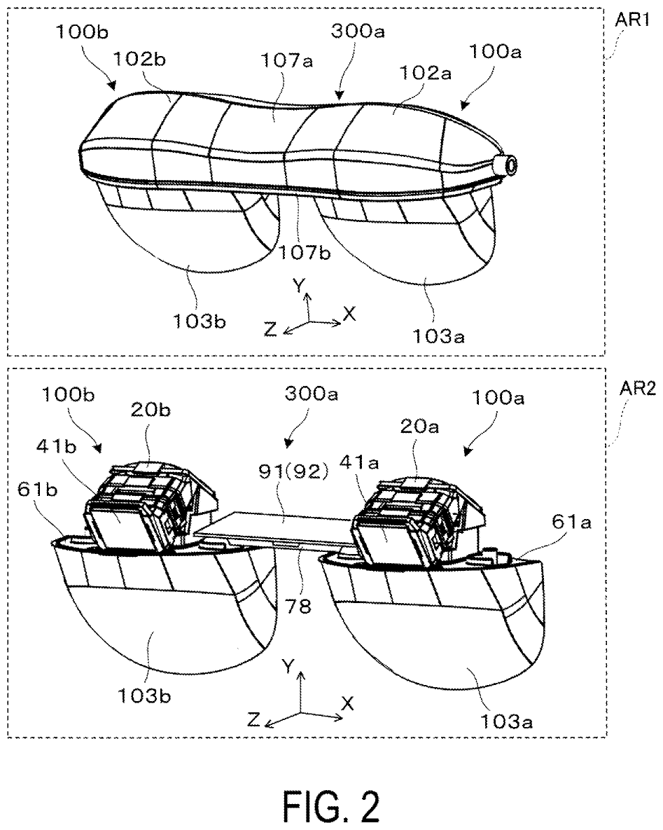

A structure and the like of the main body device 300a of the image display device 300 will be described referring to FIG. 2. In FIG. 2, region AR1 is a perspective view of the external appearance of the main body device 300a, and region AR2 is a perspective view in which the interior of the main body device 300a is exposed.

The pair of the display drive parts 102a and 102b of the main body device 300a placed at the +Y side, that is, on the upper side, are coupled to be integrated, and are covered by a dome-shaped upper exterior member 107a that is elongated in the lateral direction, and a flat plate-shaped lower exterior member 107b. The first combiner 103a and the second combiner 103b have a shape in which the upper portion of the hemispheres protruding to the front, that is, in the +Z direction, is cut, and are placed to project downward from the lower exterior member 107b.

The first display device 100a for the left eye includes a first image element 41a, a first optical system 20a, a first frame 61a, and the first combiner 103a. The first optical system 20a and the first combiner 103a are fixed to the first frame 61a, and the first image element 41a is fixed to the first optical system 20a. The second display device 100b for the right eye includes a second image element 41b, a second optical system 20b, a second frame 61b, and the second combiner 103b. The second display device 100b for the right eye has the same structure and functions as the first display device 100a for the left eye. In other words, the second image element 41b is similar to the first image element 41a, and the second optical system 20b is similar to the first optical system 20a, and the second combiner 103b is similar to the first combiner 103a.

The first display device 100a and the second display device 100b are coupled and fixed internally via a fixing member 78. That is, the fixing member 78 supports the pair of frames 61a and 61b incorporated in the pair of display devices 100a and 100b at the center, and thus helps maintain the state in which the first display device 100a and the second display device 100b are relatively positioned. The one first frame 61a is a semi-disk-shaped metal member, and is coupled to one end of the metallic rod-shaped fixing member 78 at an inner end portion near the second frame 61b. The other second frame 61b is a semi-disk-shaped metal member, and is coupled to the other end of the rod-shaped fixing member 78 at an inner end portion near the first frame 61a. The pair of frames 61a and 61b are arranged to block a pair of openings having a similar contour that are formed in the lower-exterior member 107b.

A rectangular plate-shaped printed wired board 91 is placed on the fixing member 78 between the left and right display devices 100a and 100b. The printed wired board 91 includes a control device 92 that controls display operations of the first image element 41a and the second image element 41b. The control device 92 outputs a drive signal corresponding to a display image to the left and right image elements 41a and 41b, and controls a display operation of the left and right image elements 41a and 41b. The control device 92 can perform a process of correcting a distortion in the display image. The control device 92 includes, for example, an IF circuit, a signal processing circuit, and the like, and causes the left and right image elements 41a and 41b to display a two-dimensional image according to image data or an image signal received from the outside. Although not illustrated, the control device 92 includes a main board having an interface function for communication with an external device, which is not illustrated, and an integration function for coordinating operations of the first display device 100a with operations of the second display device 100b.

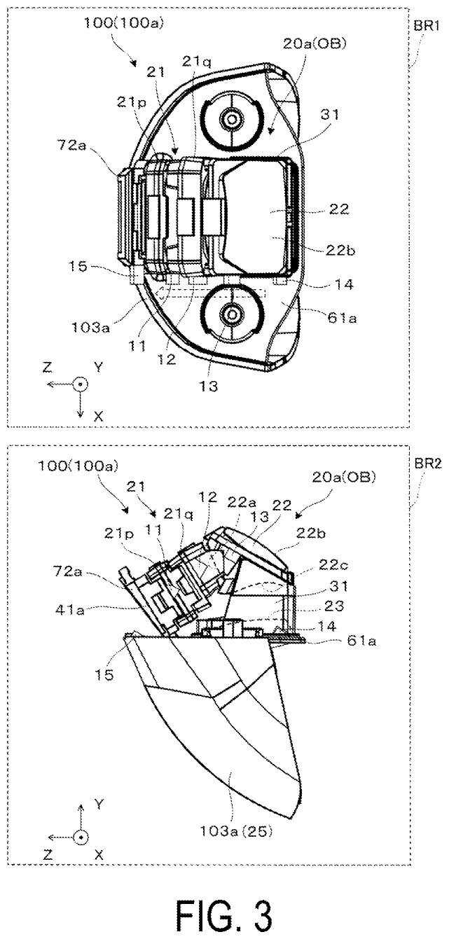

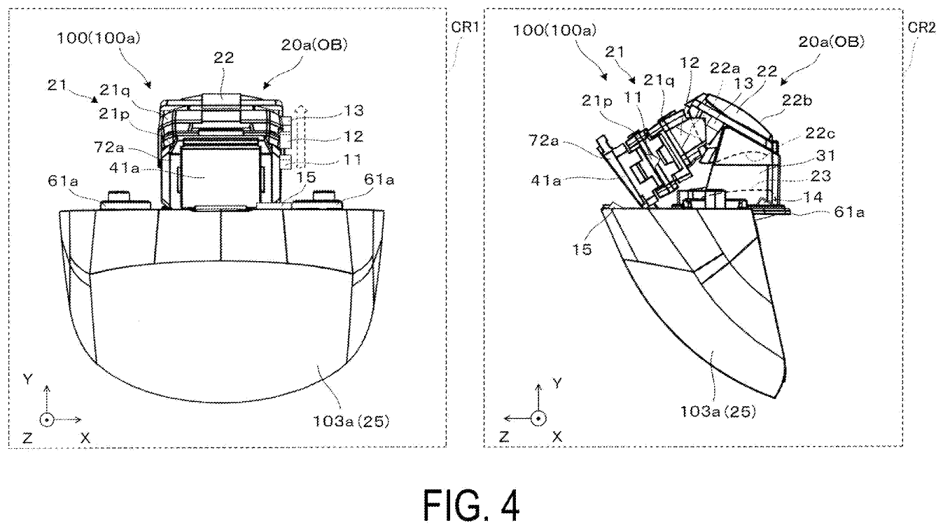

FIGS. 3 and 4 illustrate an optical unit 100 constituting the first display device 100a. In FIG. 3, region BR1 is a plan view of the optical unit 100, and region BR2 is a side view of the optical unit 100. In FIG. 4, region CR1 is a front view of the optical unit 100, and region CR2 is a side view of the optical unit 100. The optical unit 100 is an imaging optical system including the first optical system 20a, the first frame 61a, and the first combiner 103a, and is also referred to as an optical module. The first display device 100a is configured by assembling the first image element 41a into the optical unit 100. The optical unit 100 forms an image with image light incident from the first image element 41a as a virtual image.

In the optical unit 100, the first optical system 20a is fixed to the upper surface of the plate-shaped first frame 61a using adhesion, or the like, and the first combiner 103a is fixed to the front half of the circumference of the first frame 61a by adhering the upper end of the first combiner, or the like. The first optical system 20a includes a barrel 31 that supports optical elements. The barrel 31 is a support member placed between a prism mirror 22 and the first combiner 103a, or the like, supports the prism mirror 22 at an upper portion on the +Y side, and is fixed to the first frame 61a via a wedge-shaped optical element 23 at a lower portion. The prism mirror 22 supports a projection lens 21 on the front or +Z side, and the projection lens 21 supports the first image element 41a via a first holder 72a at the end portion on the side opposite to the prism mirror 22.

The projection lens 21 includes a first lens 21p and a second lens 21q. A first measurement reference member 11 that is a protruding portion is formed in the first lens 21p, and a second measurement reference member 12 that is a protruding portion is formed in the second lens 21q, and a third measurement reference member 13 that is a protruding portion is formed in the prism mirror 22. In addition, a fourth measurement reference member 14 that is a protruding portion is formed in the wedge-shaped optical element 23, and a fifth measurement reference member 15 that is a protruding portion is formed in a see-through mirror 25 that is the first combiner 103a. The first measurement reference member 11, the second measurement reference member 12, the third measurement reference member 13, the fourth measurement reference member 14, and the fifth measurement reference member 15 are arranged in a unified direction in the sense of serving as references for shape characteristics or the mutual positional relationship (see the arrows in FIGS. 3 and 4), and are collectively observable from above, that is, the +Y side, as an external appearance, and are collectively observable from behind, that is, the −Z side as an external appearance. In other words, these measurement reference members 11 to 15 can provide a relative positional relationship through collective measurement, and are used to determine a positional relationship of the projection lens 21, the prism mirror 22, the wedge-shaped optical element 23, and the first combiner 103a. The first lens 21p, the second lens 21q, the prism mirror 22, and the wedge-shaped optical element 23 correspond to a first optical member, a second optical member, a third optical member, and a fourth optical member, respectively. The see-through mirror 25 or the first combiner 103a corresponds to a fifth optical member. These optical members each have a coupling portion. The first optical member and the second optical member are directly fixed at the coupling portions, and the second optical member and the third optical member are directly fixed at the coupling portions, the third optical member and the fourth optical member are directly fixed at the coupling portions, and the fourth optical member and the fifth optical member are directly fixed at the coupling portions. The first measurement reference member 11, the second measurement reference member 12, the third measurement reference member 13, the fourth measurement reference member 14, and the fifth measurement reference member 15 are formed at non-coupling portions other than the coupling portions of the optical members.

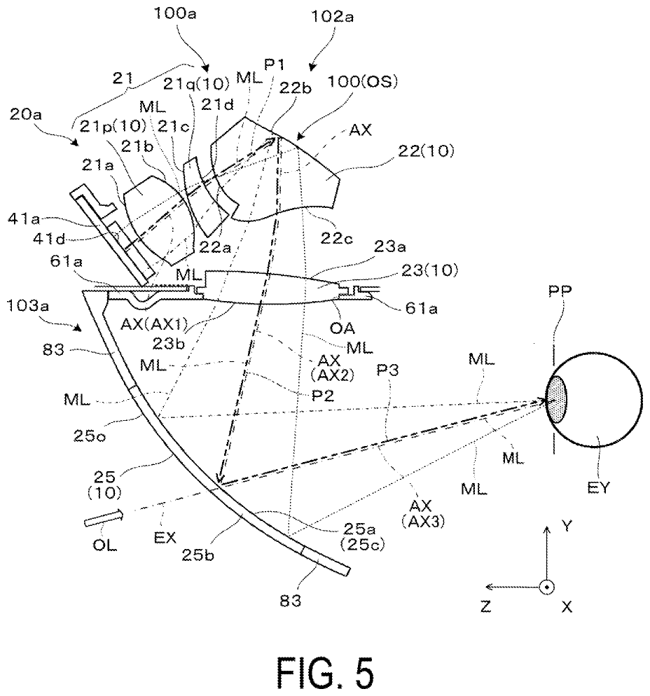

FIG. 5 is a side cross-sectional view for describing an optical structure of the first display device 100a. The first display device 100a includes the first image element 41a and the optical unit 100. The optical unit 100 includes, as optical elements, the projection lens 21, the prism mirror 22, the wedge-shaped optical element 23, and the see-through mirror 25. The projection lens 21, the prism mirror 22, and the wedge-shaped optical element 23 of the optical unit 100 correspond to the first optical system 20a illustrated in FIG. 2, and the see-through mirror 25 corresponds to the first combiner 103a. In the optical unit 100, the wedge-shaped optical element 23 is placed to fit into a step formed in an optical opening OA of the first frame 61a.

The first image element 41a is a self-luminous display device. The first image element 41a is, for example, an organic electro-luminescence (EL) display, and forms a color still image or moving image on a two-dimensional display surface 41d. The first image element 41a is not limited to an organic EL display, and can be replaced with a micro LED display, or a display device using inorganic EL, an organic LED, a laser array, a quantum dot light emission element, or the like. The first image element 41a is not limited to a self-luminous image light generation device, may include an LCD and other light modulation elements, and may form an image by illuminating the light modulation element with a light source such as a backlight. As the first image element 41a, a liquid crystal on silicon (LCOS) (LCoS is a registered trademark), a digital micro-mirror device, or the like may be used instead of the LCD.

The projection lens 21 includes the first lens 21p and the second lens 21q. The first lens 21p has an incidence surface 21a and an emission surface 21b, and the second lens 21q has an incidence surface 21c and an emission surface 21d. The projection lens 21 receives image light ML emitted from the first image element 41a and then causes the image light to be incident on the prism mirror 22. The projection lens 21 focuses the image light ML emitted from the first image element 41a into a state close to a parallel luminous flux. The prism mirror 22 includes an incidence surface 22a, an inner reflection surface 22b, and an emission surface 22c. The prism mirror 22 causes the image light ML incident from the front to be emitted such that the light bends in a direction inclining downward with respect to the direction opposite to the incidence direction (the direction of the light source when viewed from the prism mirror 22). The wedge-shaped optical element 23 includes an incidence surface 23a and an emission surface 23b, and allows the image light ML emitted from the prism mirror 22 toward the see-through mirror 25 to pass therethrough. The see-through mirror 25 includes a reflection surface 25a and an outer surface 25o. The see-through mirror 25 enlarges an intermediate image formed on the light emission side of the prism mirror 22.

The optical unit 100 serves as an off-axis optical system OS due to the see-through mirror 25 being a concave mirror. In the case of this embodiment, the optical members, specifically, the projection lens 21, the prism mirror 22, the wedge-shaped optical element 23, and the see-through mirror 25 are placed to be non-axisymmetric and have an optical surface that is non-axisymmetric. In this optical unit 100, that is, the off-axis optical system OS, optical axes AX are bent such that the optical axes AX extend along an off-axis surface corresponding to the paper surface (a surface parallel to the Y-Z plane), and the optical members 21, 22, 23, and 25 are arrayed along the off-axis surface. The optical axes AX are placed in an Z shape due to a plurality of optical axis portions AX1, AX2, and AX3 each tilting at the start and end parts of the reflection surface when they are viewed on the cross section parallel to the Y-Z plane. In other words, on the off-axis surface parallel to the Y-Z plane, an optical path P1 from the projection lens 21 to the inner reflection surface 22b, an optical path P2 from the inner reflection surface 22b to the see-through mirror 25, and an optical path P3 from the see-through mirror 25 to the pupil position PP are placed to be bent in two stages in a Z shape. The off-axis surface (the surface parallel to the Y-Z plane) which is a reference surface extends parallel to the longitudinal Y direction. In this case, the optical elements 21, 22, 23, and 25 constituting the first display device 100a are arrayed by changing their height positions in the longitudinal direction.

The incidence surface 21a and the emission surface 21b of the first lens 21p constituting the projection lens 21 have asymmetry with respect to longitudinal direction parallel to the Y-Z plane and intersecting the optical axis AX with the optical axis AX interposed therebetween, and have symmetry with respect to a transverse second direction or the X direction with the optical axis AX interposed therebetween. The incidence surface 21c and the emission surface 21d of the second lens 21q constituting the projection lens 21 have asymmetry with respect to longitudinal direction parallel to the Y-Z plane and intersecting the optical axis AX with the optical axis AX interposed therebetween, and have symmetry with respect to the lateral direction or the X direction with the optical axis AX interposed therebetween. Although the first lens 21p and the second lens 21q are here formed of, for example, a resin, they may also be formed of glass. The incidence surface 21a and the emission surface 21b of the first projection lens 21p are free-form surfaces, for example. The incidence surface 21a and the emission surface 21b are not limited to free-form surfaces, and may be aspherical surfaces. The incidence surface 21c and the emission surface 21d of the second lens 21q are free-form surfaces, for example. The incidence surface 21c and the emission surface 21d are not limited to free-form surfaces, and may be aspherical surfaces. Although detailed illustration is omitted, antireflection films are formed on the incidence surfaces 21a and 21c and the emission surfaces 21b and 21d.

The prism mirror 22 is a refractive reflection optical member having a combined function of a mirror and a lens, and reflects the image light ML from the projection lens 21 while refracting it. The prism mirror 22 causes the image light ML to be incident into the inside via the incidence surface 22a, totally reflects the incident image light ML in the non-forward direction by the inner reflection surface 22b, and causes the incident image light ML to be emitted to the outside via the emission surface 22c. The incidence surface 22a, the inner reflection surface 22b, and the emission surface 22c which are the optical surfaces constituting the prism mirror 22 have asymmetry with respect to the longitudinal directions parallel to the Y-Z plane and intersecting the optical axis AX with the optical axis AX interposed therebetween, and have symmetry with respect to the lateral direction or the X direction with the optical axis AX interposed therebetween. Although the prism mirror 22 is here formed of a resin, it may also be formed of glass. A refractive index of the main body of the prism mirror 22 is set to a value such that total reflection on the inner surface is achieved in consideration of a reflection angle of the image light ML. The optical surfaces of the prism mirror 22, that is, the incidence surface 22a, the inner reflection surface 22b, and the emission surface 22c are, for example, free-form surfaces. The incidence surface 22a, the inner reflection surface 22b, and the emission surface 22c are not limited to free-form surfaces, and may be aspherical surfaces. The inner reflection surface 22b is not limited to one that reflects the image light ML by total reflection, and may be a reflection surface formed of a metal film or a dielectric multilayer film. In this case, a reflection film formed of a single layer film or multilayer film formed of a metal such as Al or Ag is formed on the inner reflection surface 22b through vapor deposition or the like, or a sheet-shaped reflection film formed of a metal is affixed thereto. Although detailed illustration is omitted, an antireflection film is formed on the incidence surface 22a and the light emission surface 22c.

The wedge-shaped optical element 23 is placed between the prism mirror 22 and the see-through mirror 25, and has a role of improving the imaging state. The incidence surface 23a and the emission surface 23b of the wedge-shaped optical element 23 have asymmetry with respect to the longitudinal direction parallel to the Y-Z plane with the optical axis AX interposed therebetween, and have symmetry with respect to the X direction, i.e. the lateral direction, perpendicular to the Y-Z plane with the optical axis AX interposed therebetween. Although the wedge-shaped optical element 23 is formed of a resin, it may also be made of glass. The incidence surface 23a and the emission surface 23b of the wedge-shaped optical element 23 are free-formed surfaces, for example. The incidence surface 23a and the emission surface 23b are not limited to free-form surfaces, and may be aspherical surfaces. Although detailed illustration is omitted, an antireflection film is formed on the incidence surface 23a and the emission surface 23b. The wedge-shaped optical element 23 has an increased thickness on the +Z side that is the front side. This makes it possible to curb the occurrence of distortion aberrations caused by prism mirror 22 or the like. The refractive index of the wedge-shaped optical element 23 differs from the refractive index of the prism mirror 22. This makes it possible to adjust the degree of refraction or dispersion between the wedge-shaped optical element 23 and the prism mirror 22, and thus, it is easy to achieve achromatism, for example.

The see-through mirror 25 is a curved plate-shaped optical member that functions as a concave-surface mirror, and reflects the image light ML from the prism mirror 22. That is, the see-through mirror 25 reflects the image light ML from the first optical system 20a toward the pupil position PP. The see-through mirror 25 covers the pupil position PP at which the eye EY or the pupil is placed, has a concave shape toward the pupil position PP, and has a convex shape toward the outside. The see-through mirror 25 covers the entire effective region of the screen in the field of view. The see-through mirror 25 is a collimator having a convergence function, and reflects the main ray of the image light ML emitted from each point on the display surface 41d that is the main ray of the image light ML temporarily spread by imaging in the vicinity of the emission region of the first optical system 20a toward the pupil position PP and converges the main ray on the pupil position PP. The see-through mirror 25 is a mirror plate having a structure in which a mirror film 25c with the transmissive property is formed on the front surface or the back surface of a plate-shaped body 25b. The see-through mirror 25 and the reflection surface 25a have asymmetry with respect to the longitudinal direction parallel to the Y-Z plane and intersecting the optical axis AX with the optical axis AX interposed therebetween, and have symmetry with respect to the lateral direction or the X direction with the optical axis AX interposed therebetween. The reflection surface 25a of the see-through mirror 25 is, for example, a free-form surface. The reflection surface 25a is not limited to a free-form surface, and may be an aspherical surface.

The see-through mirror 25 is a transmissive-type reflection element that allows transmission of some of light at the time of reflection, and the mirror film 25c of the see-through mirror 25 is formed of a reflection layer having a semi-transmissive property. Thus, because outside light OL passes through the see-through mirror 25, see-through view of the outside is enabled, and a virtual image can be superimposed on an outside image. At this time, when the plate-shaped body 25b supporting the mirror film 25c has a thickness less than or equal to approximately a few millimeters, a change in magnification of the outside image can be curbed to a small extent. A reflectance of the mirror film 25c with respect to the image light ML and the outside light OL is set to 10% or higher and 50% or lower in a range of an incidence angle of the assumed image light ML from the viewpoint of ensuring luminance of the image light ML and facilitating observation of the outside image in a see-through view. Although the plate-shaped body 25b which is a base material of the see-through mirror 25 is formed of, for example, a resin, it may also be formed of glass. The plate-shaped body 25b is formed of the same material as a support plate 83 that supports the plate-shaped body from the surrounding thereof, and has the same thickness as the support plate 83. The mirror film 25c is formed of, for example, a dielectric multilayer film including a plurality of dielectric layers having an adjusted film thickness. The mirror film 25c may be a single-layer film or a multilayer film formed of a metal such as Al or Ag of which a film thickness has been adjusted. Although the mirror film 25c may be formed by laminating, it may also be formed by affixing a sheet-shaped reflection film. An antireflection film is formed on an outer surface 25o of the plate-shaped body 25b.

An aberration reduction can be achieved by setting the lens 21p and the lens 21q constituting the projection lens 21, the prism mirror 22, the wedge-shaped optical element 23, and the see-through mirror 25 to be free-form surfaces or aspherical surfaces as described above, and, particularly when free-form surfaces are used, the optical performance of the eccentric system is easily improved, and thus an aberration of the optical unit 100 which is a non-coaxial off-axis optical system OS can be easily reduced.

To describe the optical path, the image light ML from the first image element 41a is incident on the projection lens 21 and emitted from the projection lens 21 while being substantially collimated. The image light ML that has passed through the projection lens 21 is incident on the prism mirror 22, passes through the incidence surface 22a while being refracted, is reflected by the inner reflection surface 22b with a high reflectance close to 100%, and is refracted again by the emission surface 22c. The image light ML from the prism mirror 22 is incident on the see-through mirror 25 via the wedge-shaped optical element 23 and is reflected by the reflection surface 25a with a reflectance of about 50% or lower. The image light ML reflected by the see-through mirror 25 is incident on the pupil position PP at which the eye EY or pupil of the wearer US is placed. Outside light OL that has passed through the see-through mirror 25 and the support plate 83 therearound is also incident on the pupil position PP. In other words, the wearer US wearing the first display device 100a can observe a virtual image formed from the image light ML with the virtual image overlapping on the outside image.

Although not illustrated, a light-shielding member is placed at a position between adjacent elements among the projection lens 21, the prism mirror 22, the wedge-shaped optical element 23, and the see-through mirror 25.

Positioning and fixing of elements such as the prism mirror 22, the wedge-shaped optical element 23, the projection lens 21, and the like constituting the first optical system 20a or an optical block OB illustrated in FIG. 3 will be described below.

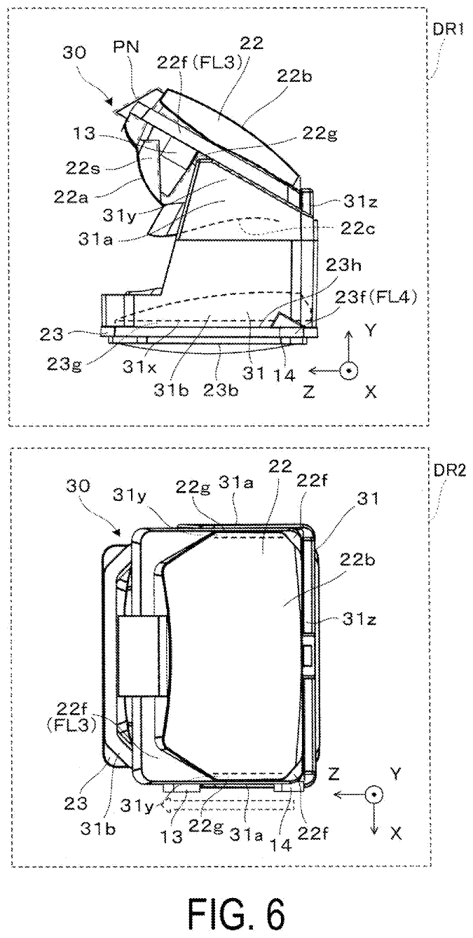

FIG. 6 is a diagram for describing a method of fixing the prism mirror 22 and the wedge-shaped optical element 23 via the barrel 31. In FIG. 6, region DR1 is a side view of an optical block main body 30 integrated by the barrel 31, and region DR2 is a plan view of the optical block main body 30. Further, the part of the optical block OB integrating the prism mirror 22 and the wedge-shaped optical element 23 using the barrel 31 will be referred to as the optical block main body 30.

The prism mirror 22 is fixed in a positioned state with respect to the barrel 31 using fitting and one-siding. Specifically, the upper surface of a pair of fitting portions 31y and the inner surface of a restriction plate 31z formed in an upper portion 31a of the barrel 31 abut against the lower surface of a flange portion 22f of the prism mirror 22, and sandwich a stepped side surface 22g of the flange portion 22f between the inner surfaces of the fitting portions 31y while supporting the prism mirror 22 in an inclining state against the fitting portions 31y. Thus, the prism mirror 22 is positioned with respect to the barrel 31 for the placement in the three axis directions (X, Y, and Z directions) and three-axial rotational postures. For the joining of the prism mirror 22 and the barrel 31, a light-curable adhesive material, an ultrasonic fusion method, or the like can be used.

The square column-shaped third measurement reference member 13 is formed in the flange portion 22f of the prism mirror 22. The third measurement reference member 13 is provided to protrude laterally from the flange portion 22f in a side surface region exposed as an external appearance of the optical block OB, which is an internal structure, of the flange portion 22f that is a frame FL3 provided on the outer side of the prism mirror 22. The position at which the third measurement reference member 13 is formed is a region of the stepped side surface 22g excluding an abutting surface or a coupling portion such as a recess portion 22s, which will be described below, or a non-coupling portion PN.

The wedge-shaped optical element 23 is fixed in a positioned state with respect to the barrel 31 using fitting. Specifically, the inner surface and the lower end surface of a fitting portion 31x corresponding to four sides of the lower portion 31b of the barrel 31 are fitted to a stepped side surface 23g and a stepped upper surface 23h of a flange portion 23f of the wedge-shaped optical element 23. Thus, the wedge-shaped optical element 23 is positioned with respect to the barrel 31 for the placement in the three axis directions and three-axial rotational postures. For the joining of the wedge-shaped optical element 23 and the barrel 31, a light-curable adhesive material, an ultrasonic fusion method, or the like can be used.

The triangular column-shaped fourth measurement reference member 14 is formed in the flange portion 23f of the wedge-shaped optical element 23. The fourth measurement reference member 14 is provided to protrude laterally from the flange portion 23f in a side surface region exposed as an external appearance of the optical block OB of the flange portion 23f that is a frame FL4 provided on the outer side of the wedge-shaped optical element 23. The position at which the fourth measurement reference member 14 is formed is a region of the stepped side surface 23g and the stepped upper surface 23h excluding a coupling portion such as an abutting surface, that is, a non-coupling portion.

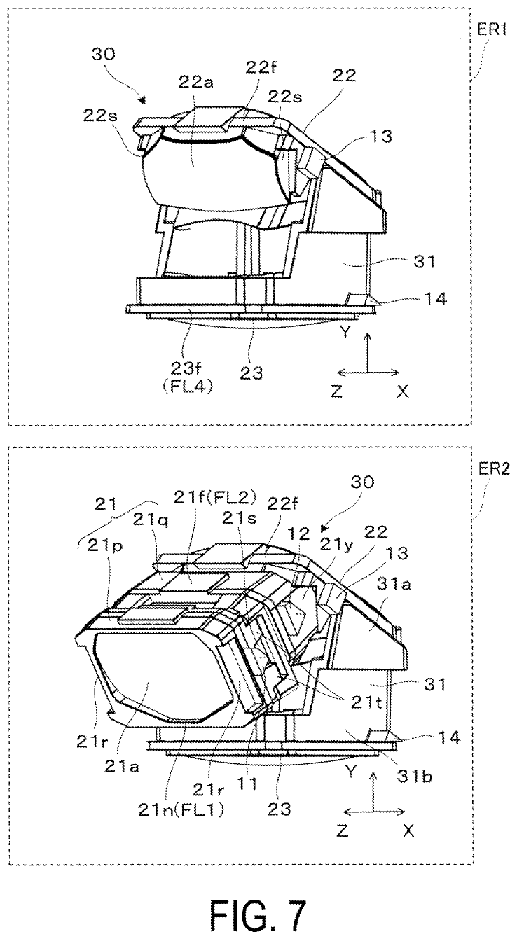

Fixation of the projection lens 21 with respect to the optical block main body 30 will be described with reference to FIG. 7. In FIG. 7, region ER1 is a perspective view of the optical block main body 30 before the projection lens 21 is fixed thereto. In FIG. 7, region ER2 is a perspective view of the optical block main body 30 with the projection lens 21 fixed thereto and the projection lens 21.

The projection lens 21 is directly fixed to the prism mirror 22 of the optical block main body 30. At this time, the projection lens 21 is fixed in a positioned state with respect to the prism mirror 22 using fitting and one-siding. Specifically, a pair of claws 21y (only one of which is illustrated) formed in the flange portion 21f of the second lens 21q constituting the projection lens 21 is inserted into a pair of recess portions 22s so as to sandwich the pair of recess portions 22s formed in the flange portion 22f of the prism mirror 22. Thus, the pair of claws 21y of the second lens 21q grip the flange portion 22f of the prism mirror 22. At this time, the pair of claws 21y are fitted to the pair of recess portions 22s, and one-siding in which the reference surfaces provided in both elements come into contact with each other is performed. Thus, the second lens 21q, that is the projection lens 21, is positioned with respect to the prism mirror 22 for the placement in the three axis directions and three-axial rotational postures. For the joining of the second lens 21q and the prism mirror 22, a light-curable adhesive material, an ultrasonic fusion method, or the like can be used.

The triangular column-shaped second measurement reference member 12 is formed in the flange portion 21f of the second lens 21q. The second measurement reference member 12 is provided to protrude laterally from the flange portion 21f in a side surface region exposed as an external appearance of the optical block OB (see FIG. 4) of the flange portion 21f that is a frame FL2 provided on the outer side of the second lens 21q. The position at which the second measurement reference member 12 is formed is a region excluding a coupling portion such as a recess portion 21s, that is, a non-coupling portion.

In the projection lens 21, the first lens 21p is directly fixed to the second lens 21q. At this time, the first lens 21p is fixed in a positioned state with respect to the second lens 21q using fitting. Specifically, two sets of claws 21t (only one set of which is illustrated) formed in a flange portion 21n of the first lens 21p is inserted into a pair of recess portions 21s so as to sandwich the pair of recess portions 21s (only one of which is illustrated) formed in the flange portion 21f of the second lens 21q. As a result, the plurality of claws 21t of the first lens 21p grip the flange portion 21f of the second lens 21q. At this time, the two sets of claws 21t are fitted to the pair of recess portions 21s. Thus, the first lens 21p is positioned with respect to the second lens 21q for the placement in the three axis directions and three-axial rotational postures. For the joining of the first lens 21p and the second lens 21q, a light-curable adhesive material, an ultrasonic fusion method, or the like can be used.

The triangular column-shaped first measurement reference member 11 is formed in the flange portion 21n of the first lens 21p. The first measurement reference member 11 is provided to protrude laterally from the flange portion 21n in a side surface region exposed as an external appearance of the optical block OB (see FIG. 4) of the flange portion 21n that is a frame FL1 provided on the outer side of the first lens 21p. The position at which the first measurement reference member 11 is formed is a region excluding a coupling portion such as a recess portion 21r, that is, a non-coupling portion.

With respect to the first lens 21p of the projection lens 21, the first holder 72a that supports the first image element 41a is directly fixed in a method similar to fixing of the first lens 21p with respect to the second lens 21q using a pair of recess portions 21r formed in the flange portion 21n of the first lens 21p.

As described above, the prism mirror 22 and the projection lens 21 constituting the optical block OB are directly fixed in the structure in which they are mutually positioned, and do not include a common member such as a mirror frame or a case. Therefore, it is possible to increase the accuracy of assembling the necessary members (specifically, those between the prism mirror 22 and the projection lens 21) while reducing the size of the optical block OB.

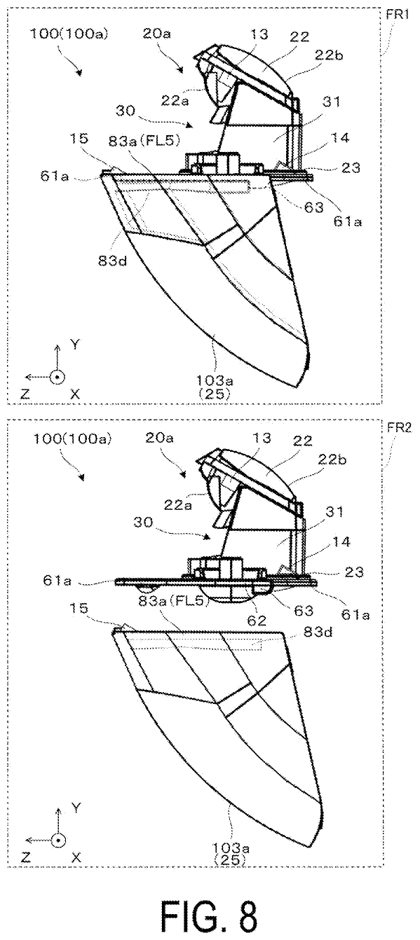

Fixing of the see-through mirror 25 or the first combiner 103a to the first frame 61a will be described with reference to FIG. 8. In FIG. 8, region FR1 is a side view illustrating a portion of the first display device 100a, and region FR2 is a side view illustrating a portion of the first display device 100a that has been disassembled.

The see-through mirror 25 is fixed in a positioned state with respect to the plate-shaped first frame 61a that supports the optical block 30 using fitting and one-siding. Specifically, a pair of protrusions 63 (only one of which is illustrated) is formed in the first frame 61a on the lower surface side in the ±X direction or the left and right end portions 62. A pair of left and right ribs 83d (only one of which is illustrated) are formed on the inner side of the see-through mirror 25 in the −Z direction along the upper edge 83a. The reference plane, which is the front ends of the projections 63 formed in the first frame 61a, abuts the reference plane, which is the rear ends of the ribs 83d formed in the see-through mirror 25. In addition, the reference plane, which is the lower surface and the side surface of the end portion 62 of the first frame 61a, abuts the reference plane, which is the upper surfaces of the ribs 83d of the see-through mirror 25 and the inner surface of the upper edge 83a. Thus, the see-through mirror 25 is positioned with respect to the first frame 61a for the placement in the three axis directions and three-axial rotational postures. For the joining of the first frame 61a and the see-through mirror 25, a light-curable adhesive material, an ultrasonic fusion method, or the like can be used. Further, the wedge-shaped optical element 23 of the optical block main body 30 is fixed in a positioned state with respect to the first frame 61a, and as a result, the see-through mirror 25 is fixed in a positioned state with respect to the wedge-shaped optical element 23.

The triangular column-shaped fifth measurement reference member 15 is formed at the upper edge 83a of the see-through mirror 25. The fifth measurement reference member 15 is provided to protrude upward from the upper edge 83a in a region exposed as an external appearance of the optical unit 100 taken out from the HMD 301 of the upper edge 83a that is a frame FL5 provided on the outer side of the see-through mirror 25. The position at which the fifth measurement reference member 15 is formed is a region excluding a coupling portion such as an inner surface of the upper edge 83a abutting the first frame 61a, that is, a non-coupling portion.

The first measurement reference member 11, the second measurement reference member 12, the third measurement reference member 13, the fourth measurement reference member 14, and the fifth measurement reference member 15 are collectively formed in a unified manner such that they are accessible from the outside using integrated molding or the like in the production of the first lens 21p, the second lens 21q, the prism mirror 22, and the see-through mirror 25. In particular, by adjusting relative placement of these elements, it is possible not only to ensure placement accuracy of the measurement reference members 11 to 15 relative to the main body but to collectively observe these measurement reference members 11 to 15. Although any one of the measurement reference members 11 to 15 can serve as a datum reference of the optical unit 100, all of them do not have to be datum references.

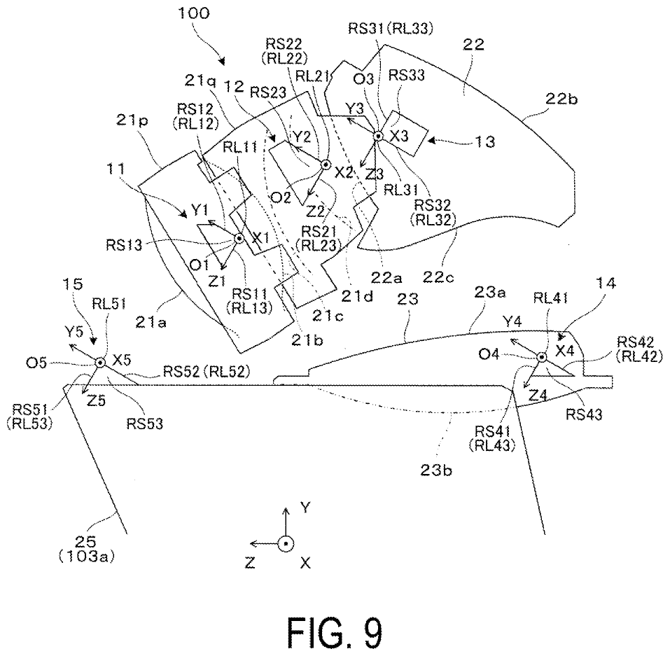

Specific forms of the individual measurement reference members 11 to 15 will be described below with reference to FIG. 9 and the like.

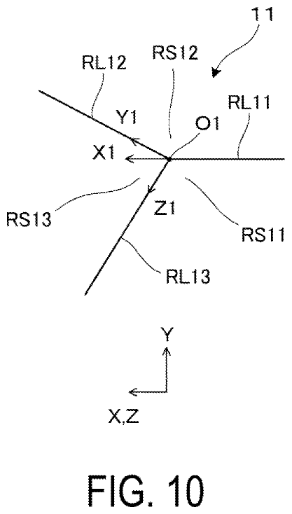

As illustrated in FIGS. 9 and 10, the first measurement reference member 11 is a member formed associated with the first lens 21p. The first measurement reference member 11 includes three measurement reference planes RS11, RS12, and RS13 as a measurement reference shape, and includes three measurement reference lines RL11, RL12, and RL13. Here, the measurement reference line RL11 corresponds to the intersection line of the pair of measurement reference planes RS11 and RS12, the measurement reference line RL12 corresponds to the intersection line of the pair of measurement reference planes RS12 and RS13, and the measurement reference line RL13 corresponds to the intersection line of the pair of measurement reference planes RS13 and RS11. The first measurement reference member 11 adopts an origin O1 and localized coordinates X1, Y1, and Z1 with respect to the placement and postures of the first lens 21p. The localized coordinates X1, Y1, and Z1 correspond to a Cartesian coordinate system for X, Y, and Z rotated around the X axis as a whole, and are orthogonal to each other. The localized coordinates X1, Y1, and Z1 are measured assuming that they are substantially orthogonal to each other with respect to real subjects. In the illustrated example, the localized coordinate X1 is on an extension line of the measurement reference line RL11, the localized coordinate Y1 matches the measurement reference line RL12, and the localized coordinate Z1 matches the measurement reference line RL13.

As illustrated in FIG. 9, the second measurement reference member 12 is a member formed associated with the second lens 21q. The second measurement reference member 12 includes three measurement reference planes RS21, RS22, and RS23 as a measurement reference shape, and includes three measurement reference lines RL21, RL22, and RL23. Here, the measurement reference line RL21 corresponds to the intersection line of the pair of measurement reference planes RS21 and RS22, the measurement reference line RL22 corresponds to the intersection line of the pair of measurement reference planes RS22 and RS23, and the measurement reference line RL23 corresponds to the intersection line of the pair of measurement reference planes RS23 and RS21. The second measurement reference member 12 adopts an origin O2 and localized coordinates X2, Y2, and Z2 with respect to the placement and postures of the second lens 21q. The localized coordinates X2, Y2, and Z2 correspond to a Cartesian coordinate system for X, Y and Z rotated around the X axis as a whole, and are designed such that the orientation is matched with the localized coordinates X1, Y1, and Z1 of the first measurement reference member 11. The localized coordinates X2, Y2, and Z2 are measured assuming that their orientations do not strictly match those of the localized coordinates X1, Y1, and Z1 with respect to real subjects. In the illustrated example, the localized coordinate X2 is on an extension line of the measurement reference line RL21, the localized coordinate Y2 matches the measurement reference line RL22, and the localized coordinate Z2 matches the measurement reference line RL23.

The third measurement reference member 13 is a member formed associated with the prism mirror 22. The third measurement reference member 13 includes three measurement reference planes RS31, RS32, and RS33 as a measurement reference shape, and includes three measurement reference lines RL31, RL32, and RL33. Here, the measurement reference line RL31 corresponds to the intersection line of the pair of measurement reference planes RS31 and RS32, the measurement reference line RL32 corresponds to the intersection line of the pair of measurement reference planes RS32 and RS33, and the measurement reference line RL33 corresponds to the intersection line of the pair of measurement reference planes RS33 and RS31. The third measurement reference member 13 adopts an origin O3 and localized coordinates X3, Y3, and Z3 with respect to the placement and postures of the prism mirror 22. The localized coordinates X3, Y3, and Z3 correspond to a Cartesian coordinate system for X, Y and Z rotated around the X axis as a whole, and are designed such that the orientation is matched with the localized coordinates X1, Y1, and Z1 of the first measurement reference member 11. The localized coordinates X3, Y3, and Z3 are measured assuming that the orientations do not strictly match those of the localized coordinates X1, Y1, and Z1 with respect to real subjects. In the illustrated example, the localized coordinate X3 is on an extension line of the measurement reference line RL31, the localized coordinate Y3 is on an extension line of the measurement reference line RL32, and the localized coordinate Z3 is on an extension line of the measurement reference line RL33.

The fourth measurement reference member 14 is a member formed associated with the wedge-shaped optical element 23. The fourth measurement reference member 14 includes three measurement reference planes RS41, RS42, and RS43 as a measurement reference shape, and includes three measurement reference lines RL41, RL42, and RL43. Here, the measurement reference line RL41 corresponds to the intersection line of the pair of measurement reference planes RS41 and RS42, the measurement reference line RL42 corresponds to the intersection line of the pair of measurement reference planes RS42 and RS43, and the measurement reference line RL43 corresponds to the intersection line of the pair of measurement reference planes RS43 and RS41. The fourth measurement reference member 43 adopts an origin O4 and localized coordinates X4, Y4, Z4, with respect to the placement and postures of the wedge-shaped optical element 23. The localized coordinates X4, Y4, and Z4 correspond to a Cartesian coordinate system for X, Y and Z rotated around the X axis as a whole, and are designed such that the orientations are matched with the localized coordinates X1, Y1, and Z1 of the first measurement reference member 11. The localized coordinates X4, Y4, and Z4 are measured assuming that the orientations do not strictly match those of the localized coordinates X1, Y1, and Z1 with respect to real subjects. In the illustrated example, the localized coordinate X4 is on an extension line of the measurement reference line RL41, the localized coordinate Y4 is on an extension line of the measurement reference line RL42, and the localized coordinate Z4 matches the measurement reference line RL43.

The fifth measurement reference member 15 is a member formed associated with the see-through mirror 25 or the first combiner 103a. The fifth measurement reference member 15 includes three measurement reference planes RS51, RS52, and RS53 as a measurement reference shape, and includes three measurement reference lines RL51, RL52, and RL53. Here, the measurement reference line RL51 corresponds to the intersection line of the pair of measurement reference planes RS51 and RS52, the measurement reference line RL52 corresponds to the intersection line of the pair of measurement reference planes RS52 and RS53, and the measurement reference line RL53 corresponds to the intersection line of the pair of measurement reference planes RS53 and RS51. The fifth measurement reference member 15 adopts an origin O5 and localized coordinates X5, Y5, and Z5 with respect to the placement and postures of the see-through mirror 25. The localized coordinates X5, Y5, and Z5 correspond to a Cartesian coordinate system for X, Y and Z rotated around the X axis as a whole, and are designed such that the orientations are matched with the localized coordinates X1, Y1, and Z1 of the first measurement reference member 11. The localized coordinates X5, Y5, and Z5 are measured assuming that the orientations do not strictly match those of the localized coordinates X1, Y1, and Z1 with respect to real subjects. In the illustrated example, the localized coordinate X5 is on an extension line of the measurement reference line RL51, the localized coordinate Y5 is on an extension line of the measurement reference line RL52, and the localized coordinate Z5 matches the measurement reference line RL53.

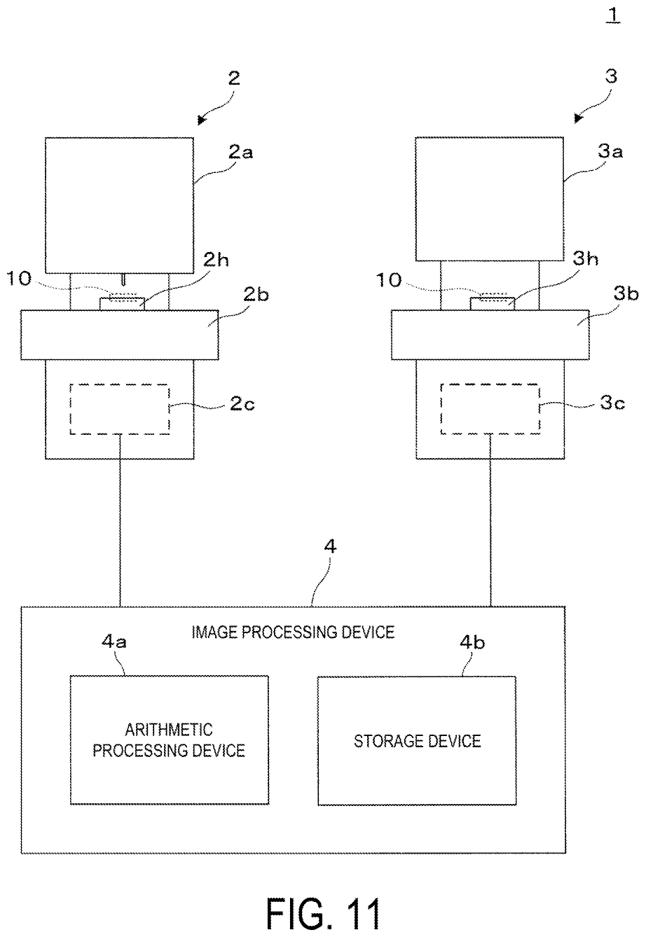

FIG. 11 is a conceptual diagram for describing a measurement system 1 of the optical unit 100. The optical unit 100 illustrated in FIG. 3 and the like includes, as optical elements, a plurality of optical members 10, specifically the lens 21p, the lens 21q, the prism mirror 22, the wedge-shaped optical element 23, and the see-through mirror 25 (see FIG. 5). The measurement system 1 evaluates the shape accuracy including the optical accuracy of each of the optical members 10 and evaluates the optical accuracy of the optical unit 100 obtained by assembling the plurality of optical members 10 using two measurement methods. The measurement system 1 includes a first measurement device 2, a second measurement device 3, and an information processing device 4.

The first measurement device 2 is, for example, a known three-dimensional shape measurement device, and includes a measuring head 2a, a stage 2b, and a drive control device 2c. When the first measurement device 2 is a three-dimensional shape measurement device, the measuring head 2a enables contact-type shape measurement using a probe that three-dimensionally displaces, for example. The stage 2b supports the optical members 10 via a holder 2h, enabling placement and postures of the optical members 10 to be set to a desired state. The drive control device 2c detects a surface shape of the optical members 10 with high accuracy by operating the measuring head 2a and the stage 2b. The drive control device 2c temporarily holds the measurement result of the surface shape of the optical members 10 and outputs the surface measurement data to the information processing device 4. The first measurement device 2 can measure a surface or a line forming a characteristic shape formed within or outside the optical surface of the optical members 10, and can determine a position and a posture of the characteristic shape. The first measurement device 2 has the optical members 10 with a plurality of optical surfaces, and when the first measurement device 2 is not capable of measuring the plurality of optical surfaces at the same time, the first measurement device re-sets the holder 2h to invert the optical members 10, and then measures the optical members 10 again.

The second measurement device 3 is, for example, a known tool microscope, and includes a measuring head 3a, a stage 3b, and a drive control device 3c. When the second measurement device 3 is a tool microscope, the measuring head 3a enables non-contact dimension measurement using, for example, an imaging optical system or an image sensor. The stage 3b supports the optical unit 100 and the optical members 10 via a holder 3h, enabling placement and postures of the optical unit 100 and the optical members 10 to be set to a desired state. The drive control device 3c causes the measuring head 3a and the stage 3b to operate, and measures the shape information such as the arrangement, dimensions, and the like of each part of the optical unit 100 and the optical members 10 with high accuracy through image processing or the like of obtained image data. The drive control device 3c temporarily holds the shape information of the optical unit 100 and the optical members 10 and outputs the shape measurement data to the information processing device 4. The second measurement device 3 can measure a surface or a line forming a characteristic shape formed within or outside the optical surface of the optical unit 100 and the optical members 10, and can determine a position and a posture of the characteristic shape associated with the optical unit 100, and the like. In determining a position and a posture of the characteristic shape, processing is performed such that a scale or graphic is fitted to the target image to aid measurement. In addition, by observing postures of the optical unit 100 and the optical members 10 in various directions using the stage 3b while changing the postures, the measurement accuracy of the characteristic shape can be improved.

The information processing device 4 is a computer, and includes an arithmetic processing device 4a and a storage device 4b. The arithmetic processing device 4a calculates, based on the surface measurement data obtained by the first measurement device 2 and the shape measurement data obtained by the second measurement device 3, unified measurement information for the shape and placement of the optical unit 100 and the optical members 10, and stores the calculation result in the storage device 4b. The information processing device 4 evaluates the optical shape of the optical members 10 based on the surface measurement data related to the plurality of optical members 10 obtained by the first measurement device 2, and evaluates the placement accuracy or assembly accuracy of the optical members 10 constituting the optical unit 100, the optical characteristics of the optical unit 100, and the like based on the shape measurement data of each part of the optical unit 100 obtained by the second measurement device 3.

Specific measurement will be described. First, a plurality of optical surfaces constituting each of the optical members 10 before assembly are measured using the first measurement device 2 illustrated in FIG. 11. In particular, the optical surfaces of the lens 21p constituting the optical member 10 include the incidence surface 21a and the emission surface 21b, the optical surfaces of the lens 21q include the incidence surface 21c and the emission surface 21d, the optical surfaces of the prism mirror 22 include the incidence surface 22a, the inner reflection surface 22b, and the emission surface 22c, the optical surfaces of the wedge-shaped optical element 23 include the incidence surface 23a and the emission surface 23b, and the optical surface of the see-through mirror 25 include the reflection surface 25a. When the plurality of optical surfaces constituting each optical member 10 is measured, for example, the measurement reference members 11 to 15 and other measurement reference members can be utilized to determine the relative placement of the plurality of optical surfaces via the measurement reference members for the plurality of optical surfaces constituting each optical member 10.

Next, after the optical unit 100 is assembled from the plurality of optical members 10, the second measurement device 3 illustrated in FIG. 11 is used to collectively measure the plurality of measurement reference members 11 to 15 provided in the optical unit 100. In measurement using the second measurement device 3, the measurement reference members 11 to 15 are collectively measured for each of the optical members 10, that is, the optical members 21p, 21q, 22, 23, and 25, and thus information regarding a relative positional relationship for the first localized coordinates X1, Y1, and Z1, the second localized coordinates X2, Y2, and Z2, the third localized coordinates X3, Y3, and Z3, the fourth localized coordinates X4, Y4, and Z4, and the fifth localized coordinates X5, Y5, and Z5 can be acquired. This relative positional relationship includes a relative positional misalignment of the origins O2 to O5 with respect to the origin O1, and the slope of other localized coordinates for the first localized coordinates X1, Y1, and Z1. The information processing device 4 can calculate and evaluate the relative rotational amount and the translational movement amount of each optical member 10 from the relative positional relationship obtained for the first localized coordinates X1, Y1, and Z1, the second localized coordinates X2, Y2, and Z2, the third localized coordinates X3, Y3, and Z3, the fourth localized coordinates X4, Y4, and Z4, and the fifth localized coordinates X5, Y5, and Z5. That is, the placement and postures of each of the optical members 10 constituting the optical unit 100 can be determined with reference to a single common localized coordinate, specifically, for example, the localized coordinate X1, Y1, or Z1, and thus the optical performance of the optical unit 100 can be collectively evaluated. Further, although the origins O1 to O5 are desirable to be placed within the same plane from the perspective of easy measurement, they may be placed to be slightly misaligned from the X direction.

Further, measurement may be performed by making various slight positional misalignments while temporarily assembling the plurality of optical members 10 with the optical unit 100 in advance, and imaging characteristics such as distortions when the positional relationship of the measurement reference members 11, 12, 13, 14, and 15 varies can be measured and made into a database. By utilizing such a database, the image formed in the first image element 41a can be corrected so as to cancel the distortion according to a relative positional misalignment obtained by measuring the optical members 21p, 21q, 22, 23, and 25 for the optical unit 100 after assembly. The correction of the image is, for example, performed by the control device 92. That is, the control device 92 corrects the image to be displayed on the first image element 41a based on the misalignment from the basic positional relationship of the plurality of optical members 21p, 21q, 22, 23, and 25. In this case, a virtual image with increased accuracy can be formed while allowing the relative positional misalignment of the optical members 21p, 21q, 22, 23, and 25.

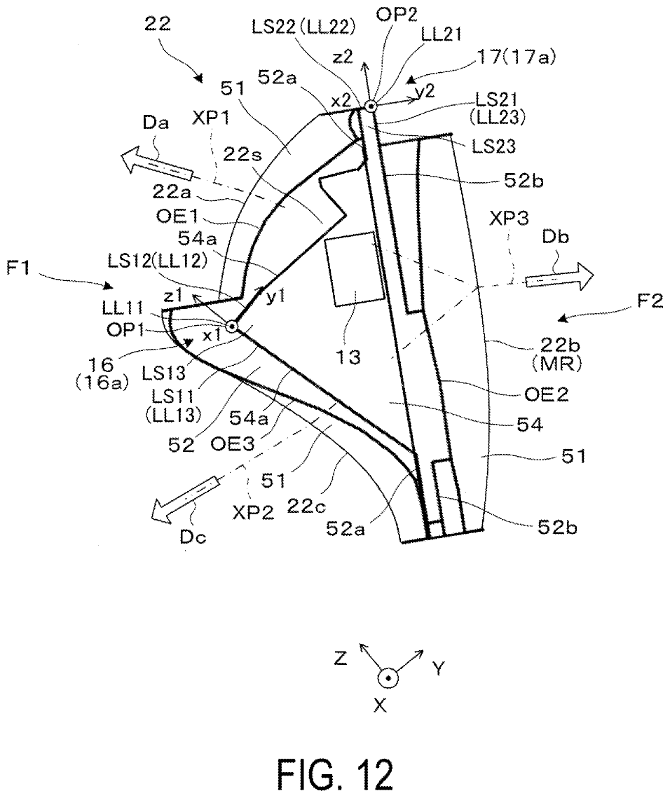

An example of a technique for measuring a plurality of optical surfaces constituting the prism mirror 22, which is one of the optical members 10, based on a unified reference will be described with reference to FIG. 12. The prism mirror 22 includes a main body 51 having a contour close to a triangular column, and a pair of frames 52 (only one of which is illustrated) provided at both end portions of the main body 51 in the ±X direction.

The main body 51 includes the incidence surface 22a, the inner reflection surface 22b, and the emission surface 22c as a plurality of optical effective surfaces as described above.

An incidence axis XP1 on the outer side of the incidence surface 22a, a main axis XP3 of the inner reflection surface 22b, and an emission axis XP2 of the emission surface 22c are in the same plane, but are inclined with each other. Here, the main axis XP3 of the inner reflection surface 22b corresponds to a bisector of the optical axis before and after the main axis passes through the inside of the main body 11 and is reflected on the inner surface of the inner reflection surface 22b. A direction Da in which the incidence axis XP1 of the incidence surface 22a is reflected and a direction Dc in which the emission axis XP2 of the emission surface 22c is reflected have an angle of 90° or lower. On the other hand, the direction Da in which the incidence axis XP1 of the incidence surface 22a is reflected or the direction Dc in which the emission axis XP2 of the emission surface 22c is reflected and a direction Db in which the main axis XP3 of the inner reflection surface 22b is reflected have an angle of 90° or higher.

In the frame 52, the protrusion portion 54 is formed on the incidence surface 22a and the emission surface 22c side. A surface 54a of the protrusion portion 54 on the optical surface side reduces the step of an outer edge OE1 of the incidence surface 22a and a step of an outer edge OE3 of the emission surface 22c in the directions Da and Dc. Thus, the incidence surface 22a and the surface 54a placed near the incidence surface can be placed within the same measuring region and targets of batch measurement in non-contact-type measurement using a microscope or the like or contact-type measurement using a probe, or the like. In this way, by reducing the step formed around the outer edge OE1 of the incidence surface 22a and the outer edge OE3 of the emission surface 22c, the incidence surface 22a and the emission surface 22c and the surface 54a placed near the surfaces are easily measured collectively, in particular, during contact-type measurement.

A portion of the protrusion portion 54 near the boundary of the incidence surface 22a and the emission surface 22c is formed of a measurement reference member 16 that provides a reference related to the placement of the incidence surface 22a and the emission surface 22c, and includes a measurement reference shape 16a. The measurement reference shape 16a includes three measurement reference planes LS11, LS12, and LS13, and includes three measurement reference lines LL11, LL12, and LL13. Here, the measurement reference line LL11 corresponds to the intersection line of the pair of measurement reference planes LS11 and LS12, the measurement reference line LL12 corresponds to the intersection line of the pair of measurement reference planes LS12 and LS13, and the measurement reference line LL13 corresponds to the intersection line of the pair of measurement reference planes LS13 and LS11. The measurement reference shape 16a adopts an origin OP1 and localized coordinates x1, y1, and z1 with respect to a first surface F1 including the incidence surface 22a and the emission surface 22c. The localized coordinates x1, y1, and z1 correspond to a Cartesian coordinate system for X, Y, and Z rotated around the X axis as a whole. In the illustrated example, the localized coordinate x1 is on an extension line of the measurement reference line LL11, the localized coordinate y1 matches the measurement reference line LL12, and the localized coordinate z1 is on an extension line of the measurement reference line LL13.

A surface 52b of the frame 52 on the optical surface side reduces the step with respect to the outer edge OE2 of the inner reflection surface 22b in the direction Db. Thus, the inner reflection surface 22b and the surface 52b placed near the inner reflection surface can be placed within the same measuring region and be targets of batch measurement in non-contact-type measurement using a microscope or the like or contact-type measurement using a probe, or the like. In this way, by reducing the step formed around the outer edge OE2 of the inner reflection surface 22b, the inner reflection surface 22b and the surface 52b placed near the inner reflection surface are easily measured collectively, in particular, during contact-type measurement.

A portion of the frame 52 on the inner reflection surface 22b side constitutes a measurement reference member 17 that functions as a reference for placement of the inner reflection surface 22b, and has an overall reference shape 17a. The overall reference shape 17a corresponds to a datum reference that is a reference for design of the prism mirror 22. The overall reference shape 17a includes three measurement reference planes LS21, LS22, and LS23, and includes three measurement reference lines LL21, LL22, and LL23. Here, the measurement reference line LL21 corresponds to the intersection line of the pair of measurement reference planes LS21 and LS22, the measurement reference line LL22 corresponds to the intersection line of the pair of measurement reference planes LS22 and LS23, and the measurement reference line LL23 corresponds to the intersection line of the pair of measurement reference planes LS23 and LS21. The measurement reference shape 17a adopts an origin OP2 and localized coordinates x2, y2, and z2 with respect to a second surface F2 including the inner reflection surface 22b. The localized coordinates x2, y2, and z2 correspond to a Cartesian coordinate system for X, Y, and Z rotated around the X axis as a whole. In the illustrated example, the localized coordinate x2 is on an extension line of the measurement reference line LL21, the localized coordinate y2 is on an extension line of the measurement reference line LL22, and the localized coordinate z2 is on an extension line of the measurement reference line LL23.

Specific measurement of the prism mirror 22 will be described. First, the first measurement device 2 illustrated in FIG. 11 is used to measure the first surface F1 of the prism mirror 22. The measurement result of the first surface F1 of the prism mirror 22 includes information related to the three-dimensional shapes of the incidence surface 22a and the emission surface 22c and information regarding the three-dimensional shape of the measurement reference shape 16a, and the information processing device 4 determines reference information of the first surface F1 (specifically, the origin OP1 and the localized coordinates x1, y1, and z1) from the three-dimensional shape of the measurement reference shape 16a, and converts the three-dimensional shapes of the incidence surface 22a and the emission surface 22c into coordinate information based on the localized coordinates x1, y1, and z1. For such coordinate conversion, a known coordinate conversion technique, that is, an arithmetic process using a matrix and a vector such as rotation and translation is used. Next, the first measurement device 2 is used to measure the second surface F2 of the prism mirror 22. The measurement result of the second surface F2 of the prism mirror 22 includes information regarding the three-dimensional shape of the inner reflection surface 22b and information regarding the three-dimensional shape of the measurement reference shape 17a, and the information processing device 4 determines reference information of the second surface F2 (specifically, the origin OP2 and the localized coordinates x2, y2, and z2) from the three-dimensional shape of the measurement reference shape 17a, and converts the three-dimensional shapes of the inner reflection surface 22b into coordinate information based on the localized coordinates x2, y2, and z2. A known coordinate conversion method is used for the coordinate conversion. Then, the second measurement device 3 illustrated in FIG. 11 is used to collectively measure the measurement reference shape 16a of the first surface F1 and the measurement reference shape 17a of the second surface F2. In the measurement using the second measurement device 3, information regarding the relative positional relationship between the localized coordinates x1, y1, and z1 and the localized coordinates x2, y2, and z2 can be acquired, and the information processing device 4 can calculate and evaluate the relative rotational amount and the translational movement amount of the localized coordinates x1, y1, and z1 and the localized coordinates x2, y2, and z2. Accordingly, the three-dimensional shape can be determined with respect to the incidence surface 22a, the inner reflection surface 22b, and the emission surface 22c, based on a single common localized coordinates x2, y2, or z2, that is, a datum reference, and the relative positional relationship between the incidence surface 22a and the inner reflection surface 22b and the emission surface 22c can be determined, and the optical performance of the prism mirror 22 can be collectively evaluated.

Although the measurement of the prism mirror 22 has been described above, the wedge-shaped optical element 23 can be similarly measured. At this time, measurement of the incidence surface 23a of the wedge-shaped optical element 23 corresponds to the measurement of the incidence surface 22a and the emission surface 22c of the prism mirror 22, and measurement of the emission surface 23b of the wedge-shaped optical element 23 corresponds to the measurement of the inner reflection surface 22b of the prism mirror 22. In other words, the incidence surface 23a is measured along with a shape corresponding to the measurement reference shape 16a, and the emission surface 23b is measured along with a shape corresponding to the measurement reference shape 17a. As a result, the relative positional relationship between the incidence surface 23a and the emission surface 23b of the wedge-shaped optical element 23 can be determined, and the optical performance of the prism mirror 22 can be collectively evaluated. Although detailed description of the lens 21p, the lens 21q, and the see-through mirror 25 is also omitted, the wedge-shaped optical element 23 can be similarly measured.

The optical unit 100 and the virtual image display device (i.e., the HMD 301) according to the first embodiment described above include a plurality of optical members 10 (see FIG. 5), the plurality of optical members 10 have the measurement reference members 11 to 15, respectively, that apply a reference related to placement in the non-coupling portion, and the plurality of measurement reference members 11 to 15 of the plurality of optical members 10 are arranged in a unified direction in the sense of serving as references based on shape characteristics or the mutual positional relationship. Because the plurality of measurement reference members 11 to 15 that serve as references for the placement of the plurality of optical members 10 are in the unified direction in this case, the positional relationship of each of the optical members 10 in a product formed by assembling the plurality of optical members 10, that is, the assembly accuracy, can be easily ascertained with high accuracy. As a result, feedback on modification of an optical component and correction of a display state is easily applied, which makes it easy to ensure and improve the image quality of virtual images.

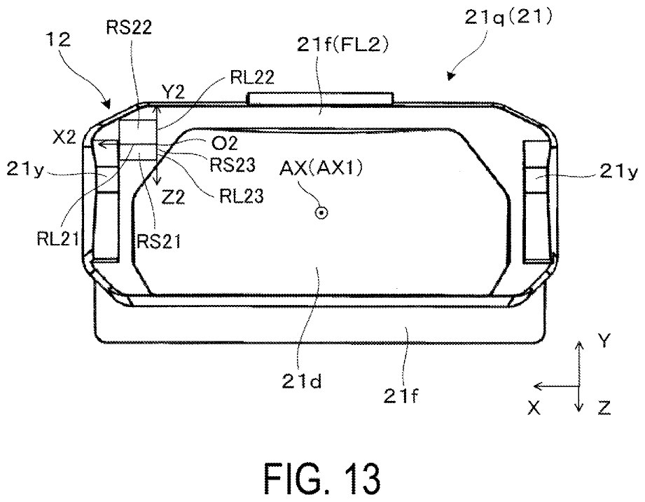

A modified example will be described with reference to FIG. 13. FIG. 13 is a diagram illustrating the prism mirror 22 side of the second lens 21q, and illustrates an example in which the forming location of the second measurement reference member 12 has been changed. The second measurement reference member 12 is formed in the flange portion 21f (that is, the frame FL2) of the second lens 21q. However, the second measurement reference member 12 is not exposed on the side surface of the second lens 21q. That is, the second measurement reference member 12 is directed toward the prism mirror 22, and the second measurement reference member 12 cannot be observed from the outside because it is behind the claws 21y after assembly. A second measurement reference member 12 of the modified example is also a member formed associated with the second lens 21q, and includes three measurement reference planes RS21, RS22, and RS23 as a measurement reference shape, and includes three measurement reference lines RL21, RL22, and RL23.

In the case of the second lens 21q illustrated in FIG. 13, although the second measurement reference member 12 is placed inside the assembled optical unit 100 and thus its external appearance cannot be observed, as a result of being placed inside, it is easy to avoid an increase in size of the optical unit 100. Even though the second measurement reference member 12 is placed inside, the placement and postures of the second measurement reference member 12 can be measured using X-ray CT or another fluoroscopic measurement technique, and the placement and assembly of the second lens 21q can be measured with high accuracy. With respect to the optical members 21p, 22, 23, and 25 other than the second lens 21q, the measurement reference members 11, 13, 14, and 15 are placed therein, and the measurement reference members 11, 13, 14, and 15 can be measured from the outside using X-ray CT or another fluoroscopic measurement technique to measure the placement and assembly accuracy of the optical members 21p, 22, 23, and 25, and the optical characteristics of the optical unit 100 can be evaluated.

Further, the second measurement reference member 12 illustrated in FIG. 13 is preferably placed while avoiding the coupling portions of the components that are hidden by adhesion of the second lens 21q, specifically, coupling spots provided on the inner sides of the claws 21y. By avoiding the coupling spots, the accuracy and reliability of fluoroscopic observation can be increased.

### Second Embodiment

Hereinafter, an optical unit and a virtual image display device according to a second embodiment of the present disclosure will be described. Further, the optical unit of the second embodiment is obtained by modifying a part of the optical unit of the first embodiment, and description of common parts will be omitted.

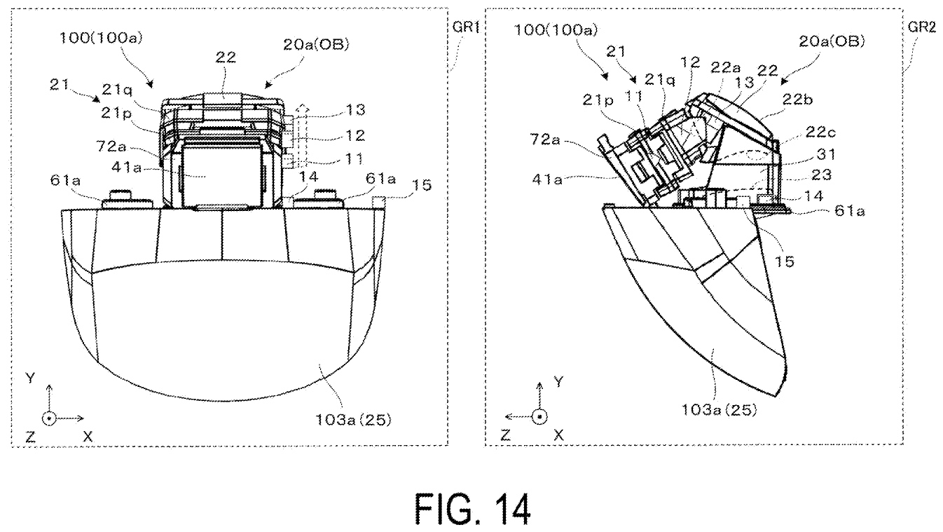

FIG. 14 illustrates an optical unit 100 according to the second embodiment. In FIG. 14, region GR1 is a front view of the optical unit 100, and region GR2 is a side view of the optical unit 100. In this case, the shape and placement of the fourth measurement reference member 14 and the fifth measurement reference member 15 differ from those of the first embodiment.

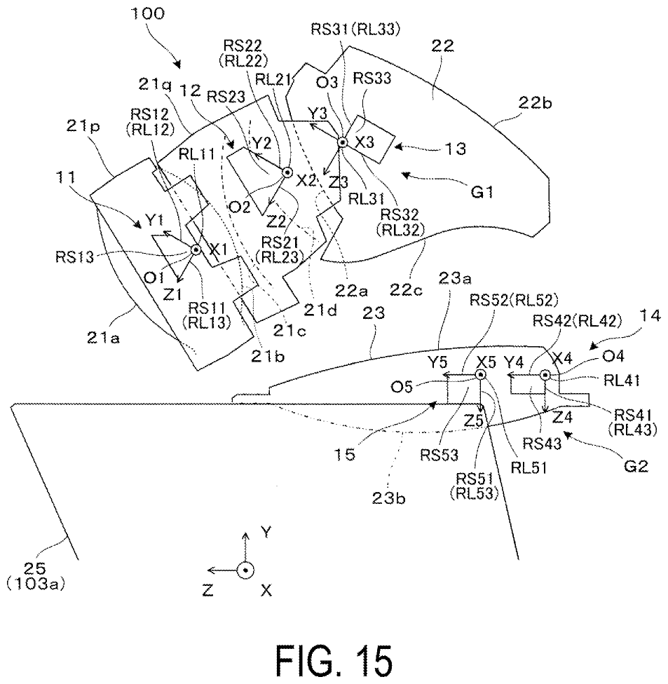

As illustrated in FIG. 15, in the optical unit 100 of the second embodiment, the fourth measurement reference member 14 is associated with a wedge-shaped optical element 23 similarly to the first embodiment, and includes measurement reference planes RS41, RS42, and RS43, and the measurement reference lines RL41, RL42, and RL43. The fourth measurement reference member 43 adopts an origin O4 and localized coordinates X4, Y4, Z4, with respect to the placement and postures of the wedge-shaped optical element 23. The localized coordinates X4, Y4, and Z4 are designed such that the orientations do not match the localized coordinates X1, Y1, and Z1 of the first measurement reference member 11.

The fifth measurement reference member 15 is associated with the see-through mirror 25 or the first combiner 103a as in the first embodiment, and includes measurement reference planes RS51, RS52, and RS53, and measurement reference lines RL51, RL52, and RL53. The fifth measurement reference member 15 adopts the origin O5 and localized coordinates X5, Y5, and Z5, with respect to the placement and postures of the wedge-shaped optical element 23. Although the localized coordinates X5, Y5, and Z5 are designed such that the orientations match those of the localized coordinates X4, Y4, and Z4 of the fourth measurement reference member 14, measurement is performed assuming that the orientations do not strictly match those of the localized coordinates X4, Y4, and Z4 with respect to real subjects.

As is clear from the above, the orientations of the coordinate systems of the first measurement reference member 11, the second measurement reference member 12, and the third measurement reference member 13 are unified. Further, the orientations of the coordinate systems of the fourth measurement reference member 14 and the fifth measurement reference member 15 are unified, unlike that of the first measurement reference member 11 and the like. That is, in a first optical member group G1 including the first lens 21p, the second lens 21q, and the prism mirror 22, the first measurement reference member 11, the second measurement reference member 12, and the third measurement reference member 13 formed therein are in a specific unified direction, and in a second optical member group G2 including the wedge-shaped optical element 23 and the see-through mirror 25, the fourth measurement reference member 14 and the fifth measurement reference member 15 formed therein are in another unified direction different from the specific direction. In other words, the plurality of measurement reference members 11, 12, and 13 formed respectively in the plurality of optical members 21p, 21q, and 22 constituting the first optical member group G1 are unified in a specific first direction in the sense of providing a reference based on the shape characteristics, and the plurality of measurement reference members 14 and 15 formed respectively in the plurality of optical members 23 and 25 constituting the second optical member group G2 are unified in a different direction from that of the measurement reference members 11, 12, and 13, and are unified in the second direction in the sense of providing a reference based on the shape characteristics. In this case, collective measurement for the first optical member group G1 including the first lens 21p to the prism mirror 22 becomes easy, and collective measurement for the second optical member group G2 including the wedge-shaped optical element 23 and the see-through mirror 25 becomes easy. With the divided the first optical member group G1 in the preceding stage and the second optical member group G2 in the subsequent stage, it is possible to divide the measurement reference before and after the optical path of the image light ML is greatly bent by the prism mirror 22, making it easier to produce and measure the measurement reference members 11, 12, 13, 14, and 15, which easily ensures measurement accuracy in the units of group or as a whole.

The optical unit 100 and the virtual image display device (i.e., the HMD 301) according to the second embodiment described above include the first optical member group G1 including the plurality of optical members 21p, 21q, and 22, and the second optical member group G2 including a plurality of other optical members 23 and 25 in which the plurality of other measurement reference members 14 and 15 in a unified direction different from that of the plurality of measurement reference members 11, 12, and 13 are formed separately from the first optical member group G1. In this case, the positional relationship of the optical members 21p, 21q, and 22, or the optical members 23 and 25 constituting each of the optical member groups G1 and G2 can be measured in the unit of the optical member group G1 or G2.

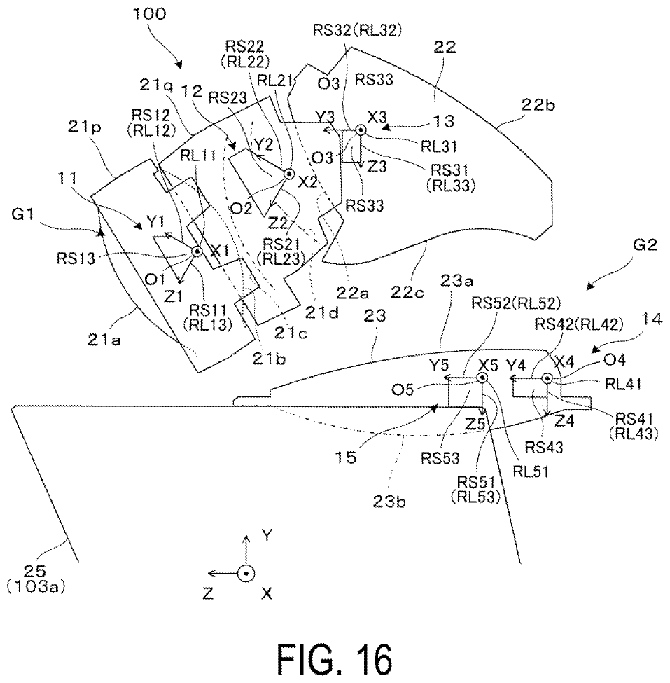

FIG. 16 is a conceptual diagram for describing a modified example of the optical unit 100 of FIG. 15. In this modified example, the third measurement reference member 13 is associated with the see-through mirror 25 similarly in the first embodiment, and includes measurement reference planes RS31, RS32, RS33, and measurement reference lines RL31, RL32, and RL33. The third measurement reference member 13 adopts the origin O3 and localized coordinates X3, Y3, and Z3, with respect to the placement and postures of the wedge-shaped optical element 23. Although the localized coordinates X3, Y3, and Z3 are designed such that the orientations do not match those of the localized coordinates X1, Y1, and Z1 of the first measurement reference member 11, the orientations match those of the localized coordinates X4, Y4, and Z4 of the fourth measurement reference member 14. As a result, the plurality of measurement reference members 11 and 12 formed respectively in the plurality of optical members 21p and 21q constituting a first optical member group G1 are unified in a specific direction, and the plurality of measurement reference members 13, 14, and 15 formed respectively in the plurality of optical members 22, 23, and 25 constituting a second optical member group G2 are unified in a different direction from that of the measurement reference members 11 and 12. In this case, the wedge-shaped optical element 23 and the see-through mirror 25 including a reflection surface are organized into the same second optical member group G2, and it is possible to intensively ascertain the positional relationship between the reflection surfaces (i.e., the inner reflection surface 22b and the reflection surface 25a) having a large influence on the display quality.

### MODIFIED EXAMPLES AND OTHERS

Although the present disclosure has been described according to the above-described embodiments, the present disclosure is not limited to the embodiments, and may be carried out in various modes within a scope not departing from the gist of the present disclosure, and, for example, the following modifications may be also be made.

The shape of the measurement reference members 11, 12, 13, 14, and 15 is not limited to a triangular pyramid, and can be a variety of shapes obtained by combining flat surfaces or edges. The measurement reference members 11, 12, 13, 14, and 15 need not be a single structure, and may include a plurality of portions, and may define a specific surface, for example, by combining a plurality of spherical surfaces and vertices. The contour shape and the shape of the optical effective surfaces of the optical members 21p, 21q, 22, 23, and 25 are not limited to those illustrated, and can be changed as appropriate according to the application. Further, the measurement reference member can be omitted for any particular optical member among the optical members 21p, 21q, 22, 23, and 25.

As a result of measuring the positional relationship of the measurement reference members 11, 12, 13, 14, and 15, when a relative misalignment is made by an allowable value or more than a standard value, the optical members 21p, 21q, 22, 23, and 25 can be assembled so as to reduce the relative misalignment when manufacturing the next optical unit 100. In addition, the optical members 21p, 21q, 22, 23, and 25 are set up, and the positional relationship of the measurement reference members 11, 12, 13, 14, and 15 is adjusted to reduce the error while measuring the positional relationship, and fixing of the optical members 21p, 21q, 22, 23, and 25 can be confirmed at the last.

The image forming characteristics obtained while changing the positional relationship of the measurement reference members 11, 12, 13, 14, and 15 can be measured and made into a database, and the imaging characteristics can be modified while modifying the positional relationship between them. Further, an image reflecting a relative positional misalignment of the optical members 21p, 21q, 22, 23, and 25 may be formed on the image element 41a.

The measurement reference members 11, 12, 13, 14, and 15 are not limited to being placed such that surfaces or lines thereof specifying a direction are placed in parallel, and can have uniformity from the perspective of having a correlation based on the premise of a constant angle difference, such as members being rotated in units of 90 degrees.

The optical unit 100 incorporated into the first display device 100a is not limited to that illustrated, and may have any of various configurations. For example, the elements constituting the optical unit 100 illustrated in FIG. 11 are merely exemplary, and they can be modified by increasing the number of lenses, adding a mirror, or adding a light guide member.

A light modulation device that modulates light by limiting light transmitted through the combiners 103a and 103b may be mounted on the outside of the combiners 103a and 103b. The light modulation device adjusts a transmittance, for example, electrically. Mirror liquid crystals, electronic shades, and the like may be used as the light modulation device. The light modulation device may adjust a transmittance according to outside light illuminance.

The combiners 103a and 103b can also be replaced with a mirror having light-shielding properties. In this case, a non-see-through optical system that is not premised on direct observation of an external image may be adopted.

The optical unit according to a specific aspect is an optical unit for imaging including a plurality of optical members, and the plurality of optical members are fixedly placed at coupling portions, and have, at non-coupling portions, measurement reference members that function as references for arrangement.

Because there are the measurement reference members that function as references for arrangement at the non-coupling portions in the optical unit, the positional relationship of each of the optical members in a product formed by assembling the plurality of optical members, that is, the assembly accuracy, can be ascertained. As a result, feedback on modification of an optical component and correction of a display state is easily applied, which makes it easy to ensure and improve the image quality of virtual images.

In a specific aspect, the directions of the plurality of measurement reference members are unified. In this case, the assembly accuracy of each optical member can be easily ascertained with high accuracy.

In a specific aspect, the plurality of measurement reference members have a measurement reference shape including either a plurality of planes or intersection lines of the plurality of planes. In this case, the references defined by the measurement reference members are identified as coordinate information based on the plurality of planes or intersection lines of the plurality of planes.

In a specific aspect, the plurality of measurement reference members are formed in the frame provided outside the plurality of optical members.

In a specific aspect, the measurement reference members are protruding portions formed in the frame of the optical members. In this case, the frame of the optical members can be effectively utilized to measure the positional relationship of each of the optical members.

In a specific aspect, the plurality of measurement reference members are collectively observable as an external appearance. In this case, the positional relationship of the plurality of measurement reference members can be collectively measured with high accuracy using an optical measurement method.

In a specific aspect, there are the first optical member group including the plurality of optical members and the second optical member group including a plurality of other optical members in which a plurality of other measurement reference members in a unified direction different from that of the plurality of measurement reference members are formed separately from the first optical member group. In this case, the positional relationship of the optical members constituting the optical member groups can be measured in units of optical member group.

In a specific aspect, the plurality of optical members include a first optical member, a second optical member, and a third optical member, the first optical member and the second optical member are fixed, the second optical member and the third optical member are fixed, the first optical member, the second optical member, and the third optical member have a first measurement reference member, a second measurement reference member, and a third measurement reference member at non-coupling portions, respectively, and the first measurement reference member, the second measurement reference member, and the third measurement reference member are arranged in a unified direction. In this case, the assembly accuracy of the first to third optical members can be easily ascertained with high accuracy.

A virtual image display device according to a specific aspect includes an image element that emits image light, and the above-described optical unit that forms an image with the image light incident from the image element as a virtual image.

The virtual image display device according to a specific aspect further includes a control device that corrects an image displayed on the image element based on a positional relationship of the plurality of optical members.

A measurement method for the optical unit according to a specific aspect is a measurement method for the optical unit including the plurality of optical members for image forming, each of the plurality of optical members has, at the non-coupling portions, a measurement reference member that serves as a reference for arrangement, the plurality of measurement reference members of the plurality of optical members have a unified direction, and a plurality of measurement reference members are collectively measured to determine a relative positional relationship between the plurality of optical members.

Because the relative positional relationship of the plurality of optical members is determined by collectively measuring the plurality of measurement reference members having a unified direction in the above-described measurement method, the assembly accuracy of a product created by assembling the plurality of optical members can be easily ascertained with high accuracy, feedback on modification of an optical component and correction of a display state can be easily applied, which makes it easy to ensure and improve the image quality of virtual images.

What is claimed is:

1. An optical unit for image forming comprising:
a plurality of optical members, wherein
the plurality of optical members are fixedly placed at coupling portions and respectively include, at non-coupling portions, a plurality of measurement reference members that serve as references for arrangement.

2. The optical unit according to claim 1, wherein the plurality of measurement reference members are arranged in a unified direction.

3. The optical unit according to claim 1, wherein the plurality of measurement reference members have measurement reference shapes including either a plurality of planes or an intersection line of the plurality of planes.

4. The optical unit according to claim 1, wherein each of the plurality of measurement reference members is formed at a frame provided outside the plurality of optical members.

5. The optical unit according to claim 4, wherein the plurality of measurement reference members are protruding portions formed at the frame of the optical members.

6. The optical unit according to claim 1, wherein the plurality of measurement reference members are collectively observable as an external appearance.

7. The optical unit according to claim 1, further comprising:
a first optical member group including the plurality of optical members; and
a second optical member group including a plurality of other optical members in which a plurality of other measurement reference members in a unified direction different from that of the plurality of measurement reference members are formed, the second optical member group being different from the first optical member group.

8. The optical unit according to claim 1, wherein
the plurality of optical members include a first optical member, a second optical member, and a third optical member,
the first optical member and the second optical member are fixed,
the second optical member and the third optical member are fixed,
the first optical member, the second optical member, and the third optical member have a first measurement reference member, a second measurement reference member, and a third measurement reference member at the non-coupling portions, respectively, and
the first measurement reference member, the second measurement reference member, and the third measurement reference member are arranged in a unified direction.

9. A virtual image display device comprising:
an image element configured to emit image light; and
the optical unit according to claim 1 configured to form an image with the image light incident from the image element as a virtual image.

10. The virtual image display device according to claim 9, further comprising:
a control device configured to correct an image displayed on the image element based on a positional relationship of the plurality of optical members.

11. A measurement method for an optical unit for image forming including a plurality of optical members, wherein
the plurality of optical members respectively have, at non-coupling portions, measurement reference members that serve as references for arrangement,
the plurality of measurement reference members of the plurality of optical members are arranged in a unified direction, and
the plurality of measurement reference members are collectively measured to determine a relative positional relationship of the plurality of optical members.
